(19) United States
(12) Patent Application Publication
(10) Pub. No.: US 2026/0032017 A1
(43) Pub. Date: Jan. 29, 2026

(54) USER EQUIPMENT-AGGREGATION CONTROL METHOD AND APPARATUS THEREOF

(71) Applicant: MediaTek Singapore Pte. Ltd., Singapore (SG)

(72) Inventors: Mengmeng SUN, Beijing (CN); Yan WU, Beijing (CN); Chun TAI, Hsinchu City (TW); Tao CHEN, Beijing (CN); Jianwei ZHANG, Beijing (CN); Yongtuan QIAO, Beijing (CN); Min LEI, Beijing (CN)

(21) Appl. No.: 18/788,696

(22) Filed: Jul. 30, 2024

(30) Foreign Application Priority Data
Jul. 24, 2024 (CN) 202410996400.6

(51) Int. Cl. H04L 12/46; H04W 76/12; H04W 88/04

(52) U.S. Cl. CPC H04L 12/4633; H04W 76/12; H04W 88/04

(57) ABSTRACT

A user equipment (UE) aggregation control method is provided. The UE aggregation control method may be applied to a UE. The UE aggregation control method may include the following steps. The UE may perform an application to initiate UE aggregation with a relay UE and to establish a non-3rd Generation Partnership Project (3GPP) connection between the UE and the relay UE to achieve UE aggregation. Then, the UE may transmit encapsulated data packets to the relay UE, which are transmitted to a network node after decapsulated. The encapsulated data packets comprise headers containing address information and port information of the UE and the relay UE.

### CROSS-REFERENCE TO RELATED APPLICATIONS

This application claims the benefits of CN patent application No. 202410996400.6 filed on Jul. 24, 2024, the entirety of which is incorporated by reference herein.

### BACKGROUND OF THE INVENTION

### Field of the Invention

The invention generally relates to wireless communications technology, and more particularly, to the user equipment (UE) aggregation control with respect to multiple user equipments (UEs) and network apparatus in mobile communications.

### Description of the Related Art

GSM/GPRS/EDGE technology is also called 2G cellular technology, WCDMA/CDMA-2000/TD-SCDMA technology is also called 3G cellular technology, and LTE/LTE-A/TD-LTE technology is also called 4G cellular technology. These cellular technologies have been adopted for use in various telecommunication standards to provide a common protocol that enables different wireless devices to communicate on a municipal, national, regional, and even global level. An example of an emerging telecommunication standard is the 5G New Radio (NR). The 5G NR is a set of enhancements to the LTE mobile standard promulgated by the Third Generation Partnership Project (3GPP). It is designed to better support mobile broadband Internet access by improving spectral efficiency, reducing costs, and improving services.

In a wireless communication system, a user equipment (UE), known as remote UE or primary device, connects to one or more auxiliary user equipment, known as relay UE or assisting device, to jointly communicate with network apparatus, with the aim of enhancing transmission bandwidth and capacity. This technology is referred to as user equipment (UE) aggregation, device cooperation, or sidelink relay enhancement. This invention is proposed for cooperative communication between a remote UE, one or more relay UE(s) and the network apparatus. Therefore, how to establish connections between UEs and realize the UE aggregation operation more easily and conveniently is a topic that is worthy of discussion.

### BRIEF SUMMARY OF THE INVENTION

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

One objective of the present disclosure is to propose schemes, concepts, designs, systems, methods and apparatus pertaining to user equipment (UE) aggregation control with respect to UE, relay UE and network apparatus in mobile communications. It is believed that the above-described issue would be avoided or otherwise alleviated by implementing one or more of the proposed schemes described herein.

An embodiment of the invention provides a UE aggregation control method. The UE aggregation control method may be applied to a UE. The UE aggregation control method may comprise the following steps. The UE may perform an application to establish a connection with a relay UE to achieve UE aggregation. This connection is not defined within the scope of 3GPP (3rd generation partnership project) specifications and is referred to as a non-3GPP connection, such as a Bluetooth connection, a Wi-Fi connection, a cable connection, and so on. Then, to ensure the consistency of cooperation between the remote UE and the relay UE, the data transmitted between UEs may undergo special encapsulation and decapsulation. The UE acting as the relay UE may provide some information, such as available bandwidth size, data transmission status, etc., to the remote UE. The UE acting as the remote UE needs to perform special processing based on this information. Then, the UE may transmit encapsulated data packets to the relay UE, which are transmitted to a network node after decapsulated, wherein the encapsulated data packets comprise headers which containing address information and port information of the UE and the relay UE.

In some embodiments, the UE may display a control interface corresponding to the application after the application is performed. Then, the UE may initiate or terminate the UE aggregation through the control interface.

In some embodiments, the UE may receive an electronic bill from the relay UE after the UE aggregation is terminated. The billing method for the electronic bill may be calculated based on the UE's data usage multiplied by the unit price of the data traffic. The unit price of the data may be provided by the operator or the user of the relay UE.

In some embodiments, the UE may disconnect the non-3GPP connection after paying the electronic bill to the relay UE.

In some embodiments, the UE may determine whether the network node supports the UE aggregation through the non-3GPP connection before initiating the UE aggregation through the non-3GPP connection with the relay UE.

In some embodiments, the UE may encapsulate PDCP (packet data convergence protocol) data packets, such as adding internet protocol (IP) header and transport protocol header with address information and port information. The UE on the other side of the non-3GPP connection needs to decapsulate the packets, removing the address information and port information accordingly, and restoring the PDCP data packets to their original form.

In some embodiments, the address information may comprise internet protocol (IP) addresses of the UE and the UE on the other side of the non-3GPP connection, and the port information may comprise user datagram protocol (UDP) ports or transmission control protocol (TCP) ports of the UE and the UE on the other side of the non-3GPP connection.

In some embodiments, the UE may receive transmission bandwidth information of the non-3GPP connection and transmission bandwidth information between the relay UE and the network node from the relay UE. Then, the UE may adjust the amount of data packets transmitted to the relay UE according to the transmission bandwidth information of the non-3GPP connection and the transmission bandwidth information between the relay UE and the network node.

In some embodiments, the transmission bandwidth information of the non-3GPP connection and the transmission bandwidth information between the relay UE and the network node are periodically received from the relay UE.

In some embodiments, the UE may receive a feedback message for the data packets from the relay UE after the data packets are transmitted to the network node from the relay UE. Then, the UE may retransmit the data packet which has not successfully transmitted to the network node to the network node according to the feedback message.

An embodiment of the invention provides an apparatus or a user equipment (UE). The apparatus or UE may include a non-3GPP transceiver and a processor. The non-3GPP transceiver may wirelessly communicate with a relay UE. The processor is coupled to the transceiver. During operation, the processor may perform operations comprising performing an application to initiate UE aggregation with a relay UE and establish a non-3GPP connection between the UE and the relay UE to achieve UE aggregation, and transmitting, via the non-3GPP transceiver, encapsulated data packets to the relay UE, which are transmitted to a network node after decapsulated. The encapsulated data packets comprise headers which containing address information and port information of the UE and the relay UE.

Other aspects and features of the invention will become apparent to those with ordinary skill in the art upon review of the following descriptions of specific embodiments of the UE aggregation control method and apparatus for wireless communication.

### BRIEF DESCRIPTION OF THE DRAWINGS

The invention will become more fully understood by referring to the following detailed description with reference to the accompanying drawings, wherein:

FIG. 1 is a block diagram of a wireless communication system 100 according to an embodiment of the application.

FIG. 2 is a block diagram illustrating a communication apparatus according to an embodiment of the application.

FIG. 3 is a block diagram illustrating a network node according to an embodiment of the application.

FIG. 4 is a flow chart illustrating a process of establishing a non-3GPP connection to achieve UE aggregation according to an embodiment of the invention.

FIG. 5 is a schematic diagram illustrating a control interface for establishing a non-3GPP connection to achieve UE aggregation according to an embodiment of the invention.

FIG. 6 is a flow chart illustrating a process of terminating a UE aggregation according to an embodiment of the invention.

FIG. 7 is a schematic diagram illustrating a control interface for terminating a UE aggregation according to an embodiment of the invention.

FIG. 8 is a schematic diagram illustrating data packets encapsulation format according to an embodiment of the invention.

FIG. 9 is a schematic diagram illustrating process of encapsulating and decapsulating the data packets according to an embodiment of the invention.

FIG. 10 is a schematic diagram illustrating an IP header format and a UDP header format according to an embodiment of the invention.

FIG. 11 is a schematic diagram illustrating a process for transmitting the transmission bandwidth information from the relay UE according to an embodiment of the invention.

FIG. 12 is a schematic diagram illustrating a feedback message from the relay UE according to an embodiment of the invention.

FIG. 13 is a flow chart illustrating a UE aggregation control method according to an embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

According to the embodiments of the invention, the “user equipment (UE) aggregation” may mean that a remote UE can transmit data packets to at least one relay UE through a non-3rd Generation Partnership Project (3GPP) connection, and then the relay UE may transmit the data packets from the remote UE to a network node. That is, the remote UE can realize the data (or traffic) splitting through the UE aggregation.

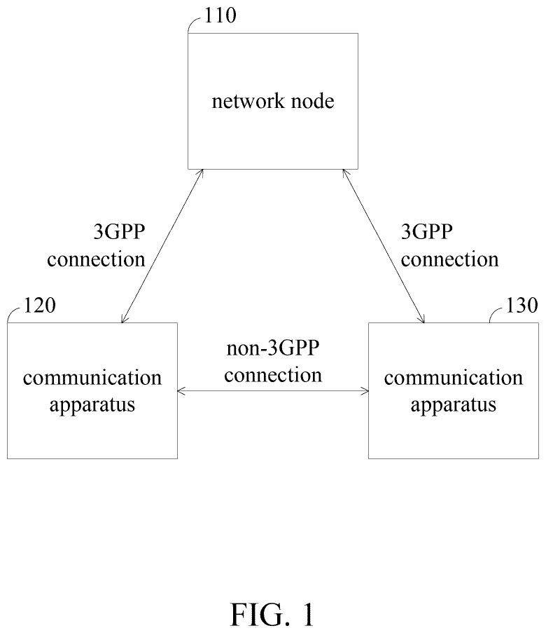

FIG. 1 is a block diagram of a wireless communication system 100 according to an embodiment of the application. As shown in FIG. 1, the wireless communication system 100 may include a network node 110, a communication apparatus 120, and a communication apparatus 130. It should be noted that, in order to clarify the concept of the invention, FIG. 1 presents a simplified block diagram in which only the elements relevant to the invention are shown. However, the invention should not be limited to what is shown in FIG. 1.

In an embodiment of the invention, the network node 110 may be a base station, a gNodeB (gNB), a NodeB (NB) an eNodeB (eNB), an access point, an access terminal, but the invention should not be limited thereto. In the embodiment, the communication apparatus 120 and the communication apparatus 130 may communicate with the network node 110 through 3GPP technologies, e.g., fourth generation (4G) communication technology, fifth generation (5G) communication technology (or 5G New Radio (NR) communication technology), or sixth generation (6G) communication technology, but the invention should not be limited thereto.

In the embodiments of the invention, each of the communication apparatus 120 and communication apparatus 130 may be UE, a smartphone, vehicle terminal, Customer Premise(s) Equipment (CPE), dongle, Personal Data Assistant (PDA), pager, laptop computer, desktop computer, wireless handset, or any computing device that includes a wireless communications interface. According to the embodiments of the invention, the communication apparatus 120 may communicate with the communication apparatus 130 through the non-3GPP technologies, e.g., Wi-Fi, Bluetooth, but the invention should not be limited thereto.

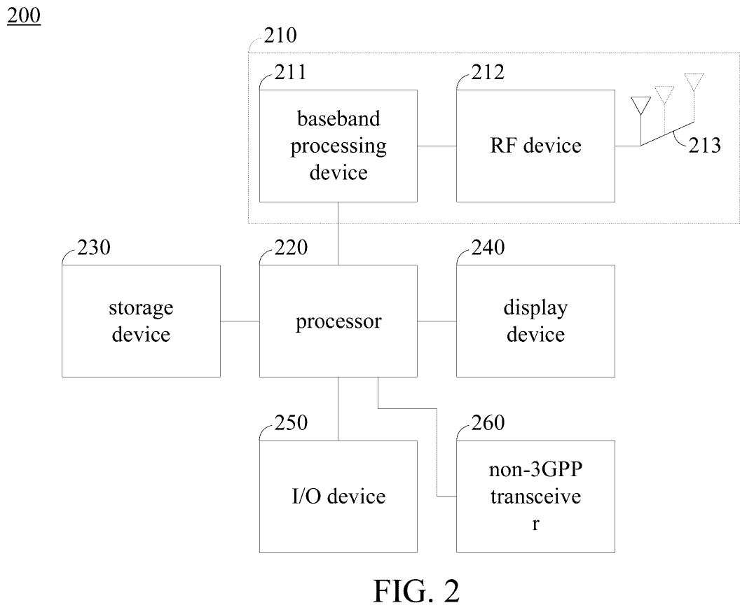

FIG. 2 is a block diagram illustrating a communication apparatus 200 according to an embodiment of the application. The communication apparatus 200 can be applied to the communication apparatus 120 and the communication apparatus 130. As shown in FIG. 2, the communication apparatus 200 may comprise a wireless transceiver 210, a processor 220, a storage device 230, a display device 240, an Input/Output (I/O) device 250, and at least one non-3rd Generation Partnership Project (3GPP) transceiver 260.

The wireless transceiver 210 may be configured to perform wireless transmission and reception to and from the communication apparatus 120.

Specifically, the wireless transceiver 210 may include a baseband processing device 211, a Radio Frequency (RF) device 212, and antenna 213, wherein the antenna 213 may include an antenna array for UL/DL MIMO.

The baseband processing device 211 may be configured to perform baseband signal processing, such as Analog-to-Digital Conversion (ADC)/Digital-to-Analog Conversion (DAC), gain adjusting, modulation/demodulation, encoding/decoding, and so on. The baseband processing device 211 may contain multiple hardware components, such as a baseband processor, to perform the baseband signal processing.

The RF device 212 may receive RF wireless signals via the antenna 213, convert the received RF wireless signals to baseband signals, which are processed by the baseband processing device 211, or receive baseband signals from the baseband processing device 211 and convert the received baseband signals to RF wireless signals, which are later transmitted via the antenna 213. The RF device 212 may comprise a plurality of hardware elements to perform radio frequency conversion. For example, the RF device 212 may comprise a power amplifier, a mixer, analog-to-digital converter (ADC)/digital-to-analog converter (DAC), etc.

According to an embodiment of the invention, the RF device 212 and the baseband processing device 211 may collectively be regarded as a radio module capable of communicating with a wireless network to provide wireless communications services in compliance with a predetermined Radio Access Technology (RAT). Note that, in some embodiments of the invention, the communication apparatus 200 may be extended further to comprise more than one antenna and/or more than one radio module, and the invention should not be limited to what is shown in FIG. 2.

The processor 220 may be a general-purpose processor, a Central Processing Unit (CPU), a Micro Control Unit (MCU), an application processor, a Digital Signal Processor (DSP), a Graphics Processing Unit (GPU), a Holographic Processing Unit (HPU), a Neural Processing Unit (NPU), or the like, which includes various circuits for providing the functions of data processing and computing, controlling the wireless transceiver 210 for wireless communications with the network node 110, storing and retrieving data (e.g., program code) to and from the storage device 230, sending a series of frame data (e.g. representing text messages, graphics, images, etc.) to the display device 240, and receiving user inputs or outputting signals via the I/O device 250.

In particular, the processor 220 coordinates the aforementioned operations of the wireless transceiver 210, the storage device 230, the display device 240, the I/O device 250, and the non-3GPP transceiver 260 for performing the method of the present application.

As will be appreciated by persons skilled in the art, the circuits of the processor 220 may include transistors that are configured in such a way as to control the operation of the circuits in accordance with the functions and operations described herein. As will be further appreciated, the specific structure or interconnections of the transistors may be determined by a compiler, such as a Register Transfer Language (RTL) compiler. RTL compilers may be operated by a processor upon scripts that closely resemble assembly language code, to compile the script into a form that is used for the layout or fabrication of the ultimate circuitry. Indeed, RTL is well known for its role and use in the facilitation of the design process of electronic and digital systems.

The storage device 230 may be a non-transitory machine-readable storage medium, including a memory, such as a FLASH memory or a Non-Volatile Random Access Memory (NVRAM), or a magnetic storage device, such as a hard disk or a magnetic tape, or an optical disc, or any combination thereof for storing data, instructions, and/or program code of applications, communication protocols, and/or the method of the present application.

The display device 240 may be a Liquid-Crystal Display (LCD), a Light-Emitting Diode (LED) display, an Organic LED (OLED) display, or an Electronic Paper Display (EPD), etc., for providing a display function. Alternatively, the display device 240 may further include one or more touch sensors for sensing touches, contacts, or approximations of objects, such as fingers or styluses.

The I/O device 250 may include one or more buttons, a keyboard, a mouse, a touch pad, a video camera, a microphone, and/or a speaker, etc., to serve as the Man-Machine Interface (MMI) for interaction with users.

The non-3GPP transceiver 260 may be a Wi-Fi transceiver or a Bluetooth transceiver.

The communication apparatus 200 may establish a non-3GPP connection with a relay UE through non-3GPP transceiver 260. Then, the communication apparatus 200 may perform a non-3GPP connection with a relay UE to achieve UE aggregation.

According to an embodiment of the invention, the wireless transceiver 210 may be configured in a modem (MD) of the communication apparatus 200, and the processor 220 may be configured in an application processor (AP) of the communication apparatus 200.

It should be understood that the components described in the embodiment of FIG. 2 are for illustrative purposes only and are not intended to limit the scope of the application. For example, a communication apparatus may include more components, such as another wireless transceiver for providing telecommunication services, a Global Positioning System (GPS) device for use of some location-based services or applications, and/or a battery for powering the other components of the communication apparatus, etc. Alternatively, a communication apparatus may include fewer components.

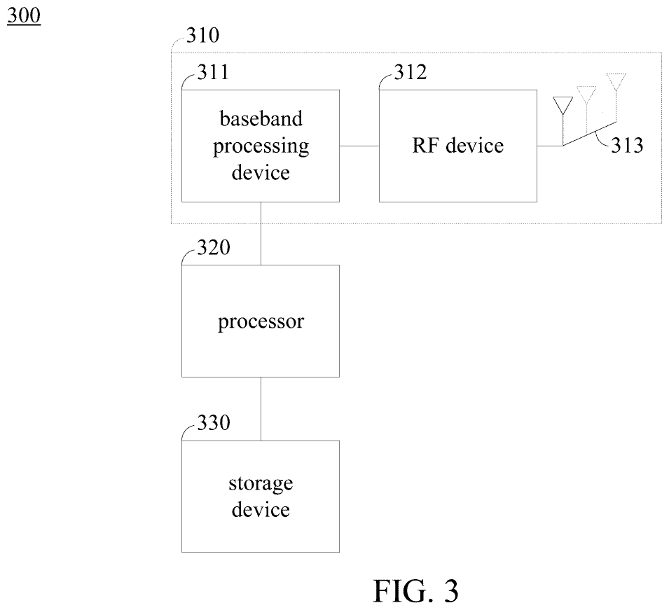

FIG. 3 is a block diagram illustrating a network node 300 according to an embodiment of the application. The network node 300 can be applied to the network node 110. As shown in FIG. 3, the network node 300 may comprise a wireless transceiver 310, a processor 320, and a storage device 330.

The wireless transceiver 310 is configured to perform wireless transmission and reception to and from one or more communication apparatuses (e.g., the communication apparatus 120).

Specifically, the wireless transceiver 310 may include a baseband processing device 311, an RF device 312, and antenna 313, wherein the antenna 313 may include an antenna array for UL/DL MU-MIMO.

The baseband processing device 311 is configured to perform baseband signal processing, such as ADC/DAC, gain adjusting, modulation/demodulation, encoding/decoding, and so on. The baseband processing device 311 may contain multiple hardware components, such as a baseband processor, to perform the baseband signal processing.

The RF device 312 may receive RF wireless signals via the antenna 313, convert the received RF wireless signals to baseband signals, which are processed by the baseband processing device 311, or receive baseband signals from the baseband processing device 311 and convert the received baseband signals to RF wireless signals, which are later transmitted via the antenna 313. The RF device 312 may comprise a plurality of hardware elements to perform radio frequency conversion. For example, the RF device 312 may comprise a power amplifier, a mixer, analog-to-digital converter (ADC)/digital-to-analog converter (DAC), etc.

The processor 320 may be a general-purpose processor, an MCU, an application processor, a DSP, a GPH/HPU/NPU, or the like, which includes various circuits for providing the functions of data processing and computing, controlling the wireless transceiver 310 for wireless communications with the communication apparatus 120, and storing and retrieving data (e.g., program code) to and from the storage device 330.

In particular, the processor 320 coordinates the aforementioned operations of the wireless transceiver 310 and the storage device 330 for performing the method of the present application.

In another embodiment, the processor 320 may be incorporated into the baseband processing device 311, to serve as a baseband processor.

As will be appreciated by persons skilled in the art, the circuits of the processor 320 may include transistors that are configured in such a way as to control the operation of the circuits in accordance with the functions and operations described herein. As will be further appreciated, the specific structure or interconnections of the transistors may be determined by a compiler, such as an RTL compiler. RTL compilers may be operated by a processor upon scripts that closely resemble assembly language code, to compile the script into a form that is used for the layout or fabrication of the ultimate circuitry. Indeed, RTL is well known for its role and use in the facilitation of the design process of electronic and digital systems.

The storage device 330 may be a non-transitory machine-readable storage medium, including a memory, such as a FLASH memory or a NVRAM, or a magnetic storage device, such as a hard disk or a magnetic tape, or an optical disc, or any combination thereof for storing data, instructions, and/or program code of applications, communication protocols, and/or the method of the present application.

It should be understood that the components described in the embodiment of FIG. 3 are for illustrative purposes only and are not intended to limit the scope of the application. For example, a network node may include more components, such as a display device for providing a display function, and/or an I/O device for providing an MMI for interaction with users.

According to an embodiment of the invention, a remote UE (e.g., communication apparatus 120) may perform an application to establish a non-3GPP connection with a relay UE (e.g., communication apparatus 130) to achieve UE aggregation. That is, the remote UE may enable the UE aggregation function through the application.

According to an embodiment of the invention, after the application is performed, a display device of the remote UE may display a control interface corresponding to the application. The UE aggregation with the relay UE can be initiated or terminated through the control interface.

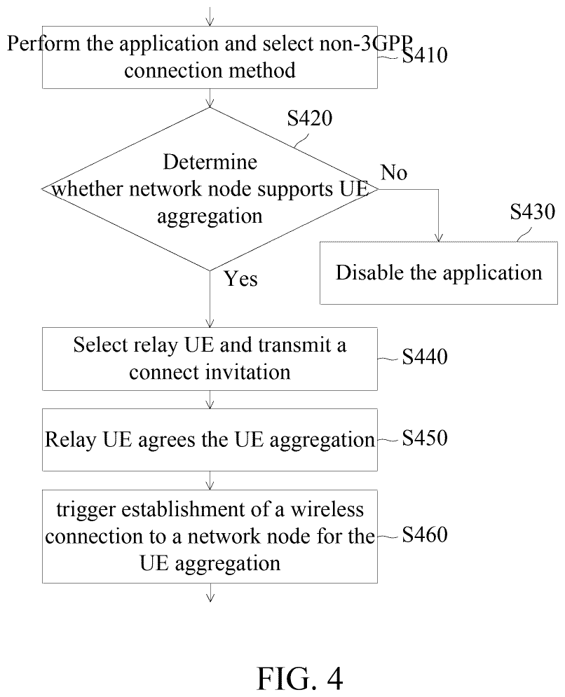

According to an embodiment of the invention, before establishing the non-3GPP connection with the relay UE to achieve UE aggregation, the UE may determine whether the network node supports the UE aggregation through the non-3GPP connection first. If the network node does not support the UE aggregation through the non-3GPP connection, the remote UE may stop establishing the non-3GPP connection with the relay UE to achieve UE aggregation. FIG. 4 is a flow chart illustrating a process of establishing a non-3GPP connection to achieve UE aggregation according to an embodiment of the invention. The process can be applied in the communication apparatus 120 and the communication apparatus 130. As shown in FIG. 4, in step S410, when a remote UE (e.g., the communication apparatus 120) wants to establish a non-3GPP connection with a relay UE (e.g., the communication apparatus 130) to achieve UE aggregation, the remote UE and the relay UE may perform an application for UE aggregation to establish the non-3GPP connection between the communication apparatus 120 and the communication apparatus 130.

In step S420, the remote UE may determine whether the network node supports the UE aggregation through the non-3GPP connection. For example, the remote UE may receive system information block (SIB) broadcasted by the network node, and then determine whether the network node supports the UE aggregation through the non-3GPP connection according to the SIB.

If the network node does not support the UE aggregation through the non-3GPP connection, step S430 is performed. In step S430, the remote UE and the relay UE may disable the application to stop initiating the UE aggregation.

If the network node supports the UE aggregation through the non-3GPP connection, step S440 is performed. In step S440, the remote UE and the relay UE may select a non-3GPP technology (e.g., Wi-Fi or Bluetooth) to establish the connection. That is, the remote UE and the relay UE may determine to establish which non-3GPP connection for the UE aggregation. After the remote UE and the relay UE have selected one non-3GPP technology, the remote UE may select the relay UE from a relay UE candidate list and transmit a connect invitation for UE aggregation to the relay UE.

In step S450, the relay UE may transmit a response to agree the connect invitation for UE aggregation (i.e., the relay UE may accept the connect invitation from the remote UE). In another embodiment, the relay UE may be set to automatically accept the connect invitation without transmitting a response to the remote UE (i.e., the UE aggregation function is enabled by default in the relay UE).

In step 460, the remote UE may trigger establishment of a wireless connection to a network node for the UE aggregation after the relay UE agrees the connect invitation for UE aggregation from the remote UE.

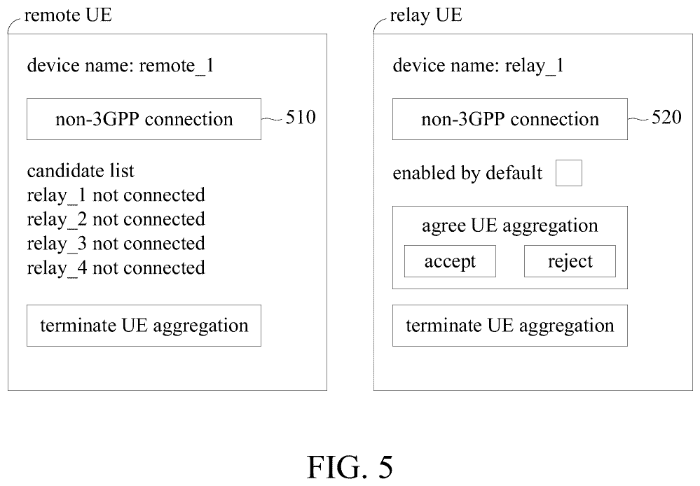

FIG. 5 is a schematic diagram illustrating a control interface for establishing a non-3GPP connection to achieve UE aggregation according to an embodiment of the invention. The control interface can be applied in the communication apparatus 120 and the communication apparatus 130. As shown in FIG. 5, when a remote UE (e.g., the communication apparatus 120) wants to establish a non-3GPP connection with a relay UE (e.g., the communication apparatus 130) to achieve UE aggregation, the remote UE and the relay UE may perform an application to establish a non-3GPP connection. After the application is performed, the display devices of the remote UE and the relay UE may display the control interface for initiating the UE aggregation.

As shown in FIG. 5, the control interface of the remote UE may display the device name of the remote UE (e.g., remote_1). The control interface of the remote UE may also display an option 510 of “non-3GPP connection” to select a non-3GPP technology (e.g., Wi-Fi or Bluetooth) to achieve the UE aggregation with the relay UE. The control interface of the remote UE may also display a rely-UE candidate list (e.g., relay_1, relay_2, relay_3 and relay_4). After the remote UE select the relay UE (e.g., relay_1) from the rely-UE candidate list, the remote UE may transmit a connect invitation to the relay UE. In addition, the control interface of the remote UE may further display an option of “terminate UE aggregation” to terminate the UE aggregation.

As shown in FIG. 5, the control interface of the relay UE may display the device name of the relay UE (e.g., relay_1). The control interface of the relay UE may also display an option 520 of “non-3GPP connection” to select a non-3GPP technology (e.g., Wi-Fi or Bluetooth) to achieve the UE aggregation with the remote UE. The control interface of the relay UE may also display an option of “enabled by default”. If the option of “enabled by default” is not selected, after the relay UE receives the connect invitation from the remote UE, a window for “accept” the connect invitation or “reject” the connect invitation will be displayed on the relay UE. When the relay UE agrees the connect invitation for the UE aggregation (i.e., the relay UE accepts the connect invitation), the UE aggregation with the remote UE will be initiated. If the option of “enabled by default” is selected, after the relay UE receives the connect invitation from the remote UE, the relay UE may automatically accept the connect invitation without transmitting a response to the remote UE (i.e., the UE aggregation function is enabled by default in the relay UE). In addition, the control interface of the relay UE may further display an option of “terminate UE aggregation” to terminate the UE aggregation.

According to an embodiment of the invention, after the UE aggregation is terminated, the remote UE may receive an electronic bill from the relay UE. Then, the remote UE may disconnect the non-3GPP connection after paying the electronic bill to the relay UE.

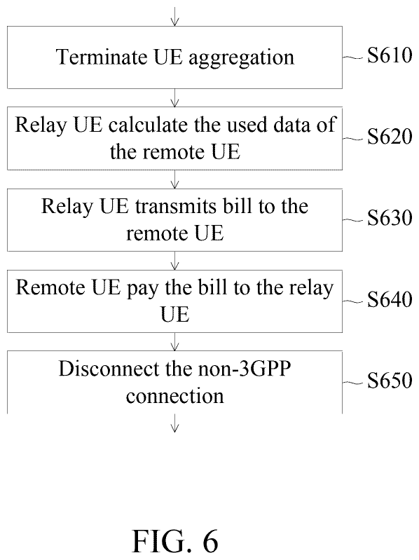

FIG. 6 is a flow chart illustrating a process of terminating a UE aggregation according to an embodiment of the invention. The process can be applied in the communication apparatus 120 and the communication apparatus 130. As shown in FIG. 6, in step S610, the remote UE (e.g., communication apparatus 120) or the relay UE (e.g., communication apparatus 130) may terminate the UE aggregation through the application, e.g., the option of “terminate UE aggregation” in the control interface of FIG. 5 is triggered on the remote UE or the relay UE.

In step S620, after the UE aggregation is terminated by the remote UE or the relay UE, the relay UE may calculate the used data of the remote UE during UE aggregation. That is, the relay UE may determine the number of bytes of the data packets transmitted or used by the remote UE during the UE aggregation.

In step S630, the relay UE may transmit an electrical bill according to the used data of the remote UE to the remote UE. That is, the relay UE may calculate the payment of the remote UE according to the used data of the remote UE. The billing method for the electronic bill may be calculated based on the UE's data usage multiplied by the unit price of the data traffic. The unit price of the data traffic may be provided by the operator or the user of the relay UE.

In step S640, the remote UE may pay the electrical bill to the relay UE.

In step S650, the remote UE may disconnect the non-3GPP connection with the relay UE after paying the bill to the relay UE.

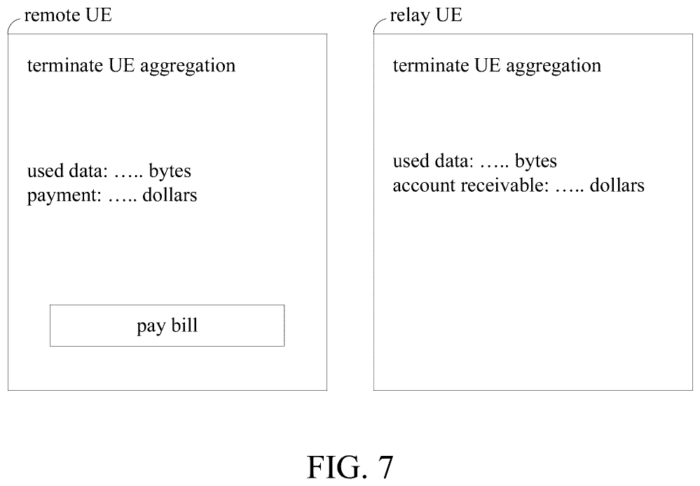

FIG. 7 is a schematic diagram illustrating a control interface for terminating a UE aggregation according to an embodiment of the invention. The process can be applied in the communication apparatus 120 and the communication apparatus 130. As shown in FIG. 7, when the remote UE (e.g., communication apparatus 120) or the relay UE (e.g., communication apparatus 130) may terminate the UE aggregation through the application, the display devices of the remote UE and the relay UE may display the control interface for terminating the UE aggregation.

As shown in FIG. 7, the control interface of the remote UE may display the used data of the remote UE (e.g., the number of bytes of the data packets used by the remote UE during the UE aggregation between the remote UE and the relay UE). The control interface of the remote UE may also display the bill of the remote UE (e.g., how may dollars the remote UE needing to pay to the relay UE). In addition, the control interface of the remote UE may further display an option of “pay bill” to pay the bill to the relay UE.

As shown in FIG. 7, the control interface of the relay UE may display the used data of the remote UE (e.g., the number of bytes of the data packets used by the remote UE during the UE aggregation between the remote UE and the relay UE). The control interface of the relay UE may also display the “account receivable” of the relay UE (e.g., how may dollars the remote UE needing to pay to the relay UE).

According to an embodiment of the invention, after the UE aggregation has been completed, the remote UE may transmit data packets to a network node (e.g., the network node 110) through the relay UE. The data packets may undergo header encapsulation and decapsulation during transmission between the UE and the relay UE, wherein the encapsulated data packet comprise headers which containing address information and port information of the UE and the relay UE. Specifically, the remote UE may encapsulate the address information and the port information with the data packets (e.g., PDCP packet data unit (PDU)) before transmitting the data packets to the relay UE through the non-3GPP connection. The relay UE may decapsulate the address information and the port information from the encapsulated data packets. Then, the relay UE may transmit the decapsulated data packets to the network node.

According to an embodiment of the invention, the address information may comprise internet protocol (IP) addresses of the remote UE and the relay UE, and the port information comprises user datagram protocol (UDP) ports or transmission control protocol (TCP) ports of the remote UE and the relay UE.

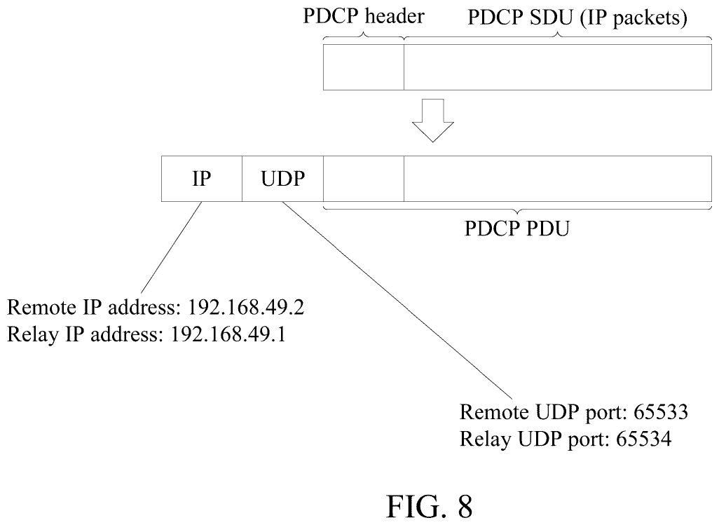

FIG. 8 is a schematic diagram illustrating data packets encapsulation format according to an embodiment of the invention. As shown in FIG. 8, the remote UE may encapsulate the address information (i.e., IP header) and the port information (i.e., UDP header) with the data packets (e.g., a PDCP PDU which comprises a PDCP header and a PDCP service data unit (SDU)) generated in the PDCP layer. The IP header may comprise IP addresses of the remote UE and the relay UE (e.g., 192.168.49.2 and 192.168.49.1). The UDP header may comprise the UDP ports of the remote UE and the relay UE (e.g., UDP port 65533 and UDP port 65534).

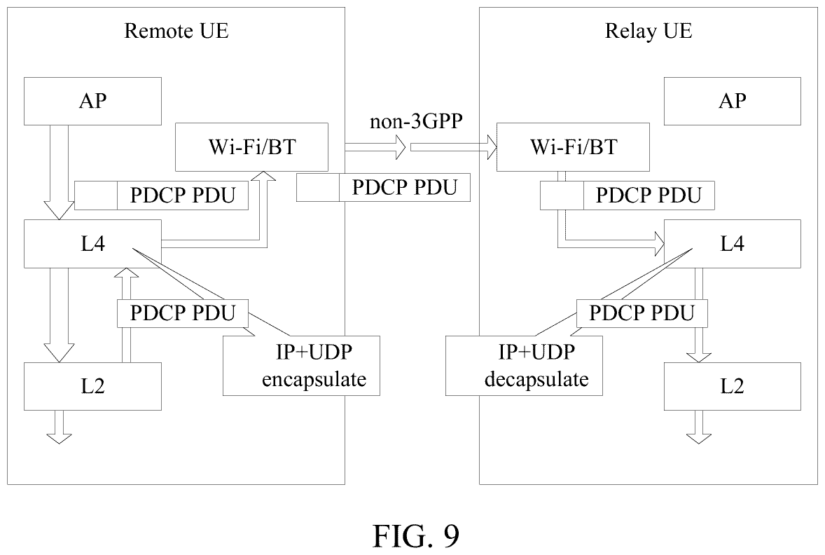

FIG. 9 is a schematic diagram illustrating process of encapsulating and decapsulating the data packets according to an embodiment of the invention. As shown in FIG. 9, in the remote UE, the IP header and the UDP header may be encapsulated with the data packets (e.g., PDCP PDU) from the layer 2 (L2) (e.g., PDCP layer) in the layer 4 (L4). Then, the encapsulated PDCP PDU may be transmitted to the relay UE through the non-3GPP connection. In the relay UE, the encapsulated IP header and UDP header from the remote UE may be decapsulated in L4, and then transmitted to L2. L4 is an example, and it is not limited to L4; it could be any layer or module capable of performing encapsulation and decapsulation.

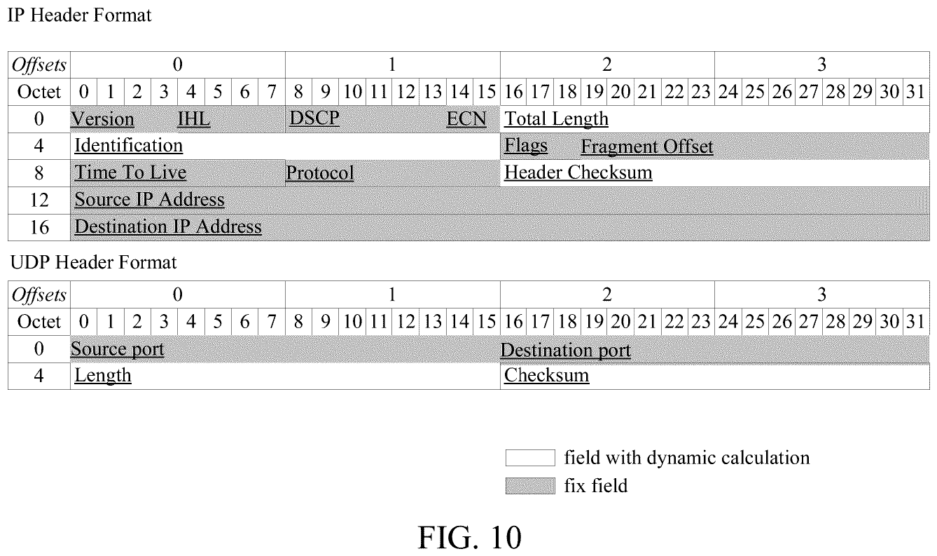

FIG. 10 is a schematic diagram illustrating an IP header format and a UDP header format according to an embodiment of the invention. As shown in FIG. 10, the IP header may be formed according to the IP header format shown in FIG. 10, and the UDP header may be formed according to the UDP header format shown in FIG. 10. The IP header format and the UDP header format may comprise the fields with dynamic value, and the fixed fields.

According to an embodiment of the invention, the remote UE may receive transmission bandwidth information of the non-3GPP connection and transmission bandwidth information between the relay UE and the network node from the relay UE. Then, the remote UE may determine whether to adjust the amount of data packets transmitted to the relay UE according to the transmission bandwidth information from the relay UE. That is, according to the transmission bandwidth information from the relay UE, the remote UE can determine how may data packets transmitted through a direct path (i.e., directly transmitted to the network node) and how many data packets transmitted through an indirect path (i.e., transmitted to the network node through the relay UE).

According to an embodiment, the relay UE may periodically transmit the transmission bandwidth information to the remote UE.

According to an embodiment, the transmission bandwidth information may comprise a bandwidth type, a bandwidth length, and a transmission rate of the bandwidth, etc.,

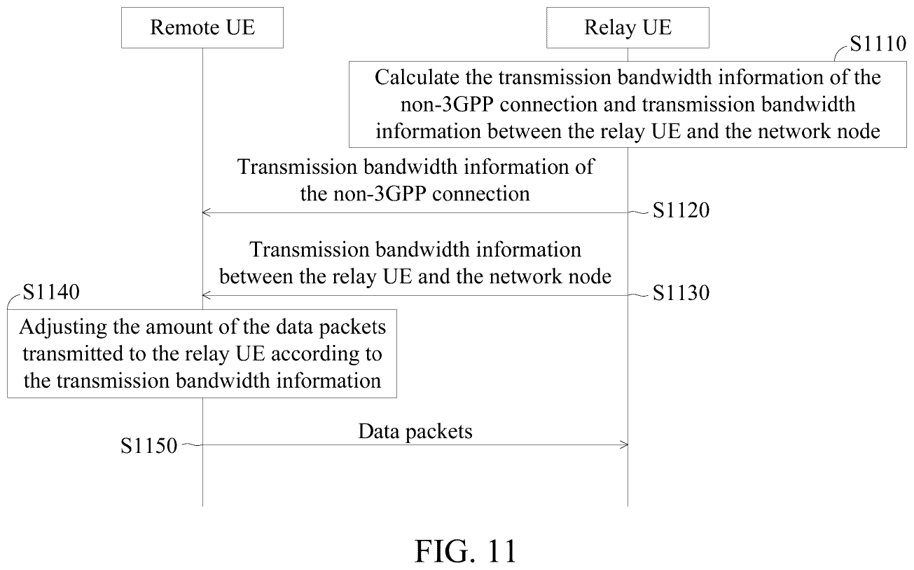

FIG. 11 is a schematic diagram illustrating a process for transmitting the transmission bandwidth information from the relay UE according to an embodiment of the invention. The process can be applied in the communication apparatus 120 and the communication apparatus 130. In step S1110, the relay UE may calculate the transmission bandwidth information of the non-3GPP connection and the transmission bandwidth information between the relay UE and the network node.

In step S1120, the relay UE may transmit the transmission bandwidth information of the non-3GPP connection to the remote UE.

In step S1130, the relay UE may transmit the transmission bandwidth information between the relay UE and the network node to the remote UE.

In step S1140, the remote UE may adjust the amount of data packets transmitted to the relay UE according to the transmission bandwidth information. That is, according to the transmission bandwidth information from the relay UE, the remote UE can determine how may data packets transmitted through a direct path (i.e., directly transmitted to the network node) and how many data packets transmitted through an indirect path (i.e., transmitted to the network node through the relay UE).

In step S1150, the remote UE may transmit the data packets to the relay UE according to the adjusted result.

According to an embodiment of the invention, after the data packets from the remote UE are transmitted to the network node through the relay UE, the remote UE may receive a feedback message (e.g., a status message with acknowledge (ACK) and negative acknowledge (NACK) information) from the relay UE indicating the transmission status of the data packets sent through the relay UE, including which data packet (or packets) is (or are) transmitted to the network node successfully and which is not. Then, the remote UE may retransmit the data packet which has not successfully transmitted to the network node to the network node according to the feedback message.

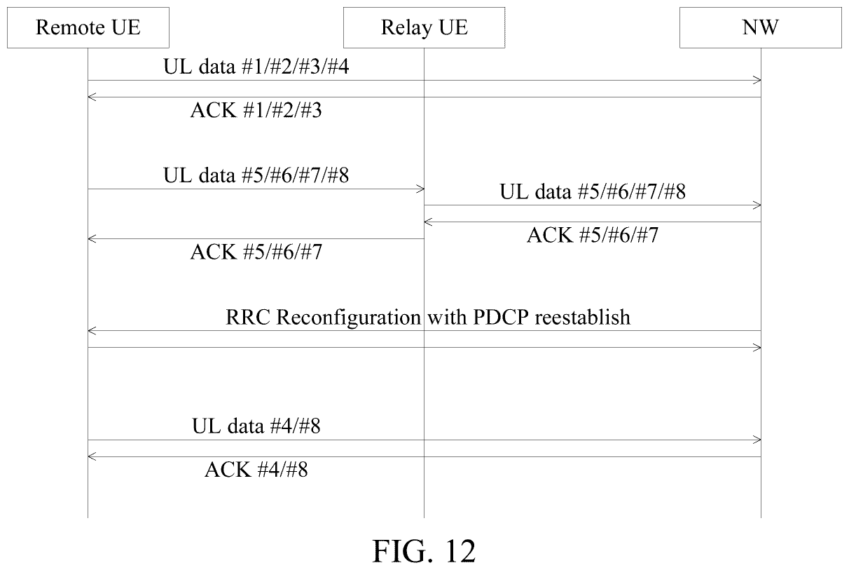

FIG. 12 is a schematic diagram illustrating a feedback message from the relay UE according to an embodiment of the invention. The process can be applied in the communication apparatus 120 and the communication apparatus 130. As shown in FIG. 12, the remote UE may transmit the uplink (UL) data packets #1, #2, #3 and #4 to the network node. Then the remote UE may receive the ACK message for the data packets #1, #2 and #3 (i.e., data packet #4 is not transmitted to the network node successfully) from the network node. In addition, the remote UE may transmit the UL data packets #5, #6, #7 and #8 to the relay UE. Then the relay UE may receive the ACK message for the data packets #5, #6 and #7 (i.e., data packet #4 needs to be retransmitted) from the network node. Then, the relay UE may transmit a feedback message for the data packets #5, #6 and #7 to indicate that the data packet #8 is not transmitted to the network node successfully, wherein the format for the feedback message may refer to the definition of PDCP Status Report in 3GPP TS 38.323. After the radio resource control (RRC) Reconfiguration with PDCP reestablish is performed between the remote UE and the network node, the remote UE may retransmit the data packets #4 and #8 which is not transmitted to the network node successfully to the network node. Then, the remote UE may receive the ACK message for the data packets #4 and #8 from the network node.

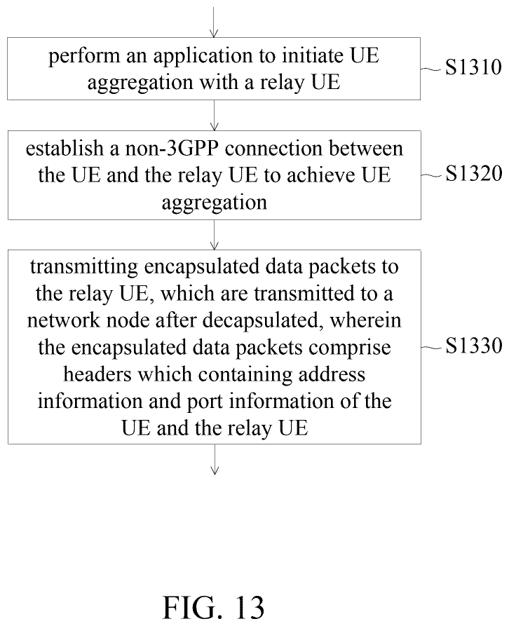

FIG. 13 is a flow chart illustrating a UE aggregation control method according to an embodiment of the invention. The UE aggregation control method can be applied in the wireless communication system 100. As shown in FIG. 13, in step S1310, a UE (e.g., communication apparatus 120) may perform an application to initiate UE aggregation with a relay UE (e.g., communication apparatus 130).

In step S1320, the UE may establish a non-3rd Generation Partnership Project (3GPP) connection between the UE and the relay UE to achieve UE aggregation.

In step S1330, the UE may transmit encapsulated data packets to the relay UE, which are transmitted to a network node after decapsulated. The encapsulated data packets comprise headers which containing address information and port information of the UE and the relay UE.

According to an embodiment of the invention, in the UE aggregation control method, the UE may display a control interface corresponding to the application after the application is performed. Then, the UE may initiate or terminate the UE aggregation through the control interface.

According to an embodiment of the invention, in the UE aggregation control method, the UE may receive an electronic bill from the relay UE after the UE aggregation is terminated.

According to an embodiment of the invention, in the UE aggregation control method, the UE may disconnect the non-3GPP connection after paying the electronic bill to the relay UE. According to an embodiment of the invention, in the UE aggregation control method, the UE may determine whether the network node supports the UE aggregation through the non-3GPP connection before initiating the UE aggregation through the non-3GPP connection with the relay UE.

According to an embodiment of the invention, in the UE aggregation control method, the UE may encapsulate the address information and the port information with the data packets.

According to an embodiment of the invention, in the UE aggregation control method, the address information may comprise IP addresses of the UE and the relay UE, and the port information may comprise UDP ports or TCP ports of the UE and the relay UE.

According to an embodiment of the invention, in the UE aggregation control method, the UE may receive transmission bandwidth information of the non-3GPP connection and transmission bandwidth information between the relay UE and the network node from the relay UE. Then, the UE may adjust the amount of data packets transmitted to the relay UE according to the transmission bandwidth information of the non-3GPP connection and the transmission bandwidth information between the relay UE and the network node.

According to an embodiment of the invention, in the UE aggregation control method, the transmission bandwidth information of the non-3GPP connection and the transmission bandwidth information between the relay UE and the network node are periodically received from the relay UE.

According to an embodiment of the invention, in the UE aggregation control method, the UE may receive a feedback message for the data packets from the relay UE after the data packets are transmitted to the network node from the relay UE. Then, the UE may retransmit the data packet which has not transmitted to the network node successfully to the network node according to the feedback message.

In the UE aggregation control method provided in the embodiments of the invention, a communication apparatus will be able to establish a non-3GPP connection with a relay UE to achieve UE aggregation.

Use of ordinal terms such as “first”, “second”, “third”, etc., in the disclosure and claims is for description. It does not by itself connote any order or relationship.

The steps of the method described in connection with the aspects disclosed herein may be embodied directly in hardware, in a software module executed by a processor, or in a combination of the two. A software module (e.g., including executable instructions and related data) and other data may reside in a data memory such as RAM memory, flash memory, ROM memory, EPROM memory, EEPROM memory, registers, a hard disk, a removable disk, a CD-ROM, or any other form of computer-readable storage medium known in the art. A sample storage medium may be coupled to a machine such as, for example, a computer/processor (which may be referred to herein, for convenience, as a “processor”) such that the processor can read information (e.g., code) from and write information to the storage medium. A sample storage medium may be integral to the processor. The processor and the storage medium may reside in an ASIC. The ASIC may reside in the UE. In the alternative, the processor and the storage medium may reside as discrete components in the UE. Moreover, in some aspects, any suitable computer-program product may comprise a computer-readable medium comprising codes relating to one or more of the aspects of the disclosure. In some aspects, a computer software product may comprise packaging materials.

It should be noted that although not explicitly specified, one or more steps of the methods described herein can include a step for storing, displaying and/or outputting as required for a particular application. In other words, any data, records, fields, and/or intermediate results discussed in the methods can be stored, displayed, and/or output to another device as required for a particular application. While the foregoing is directed to embodiments of the present invention, other and further embodiments of the invention can be devised without departing from the basic scope thereof. Various embodiments presented herein, or portions thereof, can be combined to create further embodiments. The above description is of the best-contemplated mode of carrying out the invention. This description is made for the purpose of illustrating the general principles of the invention and should not be taken in a limiting sense. The scope of the invention is best determined by reference to the appended claims.

The above paragraphs describe many aspects. Obviously, the teaching of the invention can be accomplished by many methods, and any specific configurations or functions in the disclosed embodiments only present a representative condition. Those who are skilled in this technology will understand that all of the disclosed aspects in the invention can be applied independently or be incorporated.

While the invention has been described by way of example and in terms of preferred embodiment, it should be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. A user equipment (UE) aggregation control method, applied in a UE, comprising:
performing, by a processor of the UE, an application to initiate UE aggregation with a relay UE;
establishing a non-3rd Generation Partnership Project (3GPP) connection between the UE and the relay UE to achieve UE aggregation; and
transmitting, by the processor, encapsulated data packets to the relay UE, which are transmitted to a network node after decapsulated,
wherein the encapsulated data packets comprise headers which containing address information and port information of the UE and the relay UE.

2. The UE aggregation control method of claim 1, further comprising:
displaying, by the processor, a control interface corresponding to the application after the application is performed; and
initiating or terminating, by the processor, the UE aggregation through the control interface.

3. The UE aggregation control method of claim 1, further comprising:
receiving, by the processor, an electronic bill from the relay UE after the UE aggregation is terminated.

4. The UE aggregation control method of claim 3, further comprising:
disconnecting, by the processor, the non-3GPP connection after paying the electronic bill to the relay UE.

5. The UE aggregation control method of claim 1, further comprising:
determining, by the processor, whether the network node supports the UE aggregation through the non-3GPP connection before initiating the UE aggregation with the relay UE through the non-3GPP connection.

6. The UE aggregation control method of claim 1, further comprising:
encapsulating, by the processor, the address information and the port information with data packets to generate the encapsulated data packets.

7. The UE aggregation control method of claim 1, wherein the address information comprises internet protocol (IP) addresses of the UE and the relay UE, and the port information comprises user datagram protocol (UDP) ports or transmission control protocol (TCP) ports of the UE and the relay UE.

8. The UE aggregation control method of claim 1, further comprising:
receiving, by the processor, transmission bandwidth information of the non-3GPP connection and transmission bandwidth information between the relay UE and the network node from the relay UE; and
adjusting, by the processor, the amount of the data packets transmitted to the relay UE according to the transmission bandwidth information of the non-3GPP connection and the transmission bandwidth information between the relay UE and the network node.

9. The UE aggregation control method of claim 8, wherein the transmission bandwidth information of the non-3GPP connection and the transmission bandwidth information between the relay UE and the network node are periodically received from the relay UE.

10. The UE aggregation control method of claim 1, further comprising:
receiving, by the processor, a feedback message for the data packets from the relay UE after the data packets are transmitted to the network node from the relay UE; and
retransmitting, by the processor, the data packet which has not transmitted to the network node successfully to the network node according to the feedback message.

11. An apparatus for wireless communications, comprising:
a non-3rd Generation Partnership Project (3GPP) transceiver, wirelessly communicating with a relay user equipment (UE); and
a processor, coupled to the non-3GPP transceiver, wherein during operation, the processor performs operations comprising:
performing an application to initiate UE aggregation with a relay UE;
establishing a non-3rd Generation Partnership Project (3GPP) connection between the UE and the relay UE to achieve UE aggregation; and
transmitting encapsulated data packets to the relay UE, which are transmitted to a network node after decapsulated,
wherein the encapsulated data packets comprise headers which containing address information and port information of the UE and the relay UE.

12. The apparatus of claim 11, wherein during operation, the processor performs operations comprising:
displaying, via a display device of the apparatus, a control interface corresponding to the application after the application is performed; and
initiating or terminating the UE aggregation through the control interface.

13. The apparatus of claim 11, wherein during operation, the processor performs operations comprising:
receiving, via the non-3GPP transceiver, an electronic bill from the relay UE after the UE aggregation is terminated.

14. The apparatus of claim 11, wherein during operation, the processor performs operations comprising:
disconnecting the non-3GPP connection after paying the electronic bill to the relay UE.

15. The apparatus of claim 11, wherein during operation, the processor performs operations comprising:
determining whether the network node supports the UE aggregation through the non-3GPP connection before initiating the UE aggregation through the non-3GPP connection with the relay UE.

16. The apparatus of claim 11, wherein during operation, the processor performs operations comprising:
encapsulating the address information and the port information with data packets to generate the encapsulated data packets.

17. The apparatus of claim 11, wherein the address information comprises internet protocol (IP) addresses of the UE and the relay UE, and the port information comprises user datagram protocol (UDP) ports or transmission control protocol (TCP) ports of the UE and the relay UE.

18. The apparatus of claim 11, wherein during operation, the processor performs operations comprising:
receiving, via the non-3GPP transceiver, transmission bandwidth information of the non-3GPP connection and transmission bandwidth information between the relay UE and the network node from the relay UE; and
adjusting the amount of the data packets transmitted to the relay UE according to the transmission bandwidth information of the non-3GPP connection and the transmission bandwidth information between the relay UE and the network node.

19. The apparatus of claim 18, wherein the transmission bandwidth information of the non-3GPP connection and the transmission bandwidth information between the relay UE and the network node are periodically received from the relay UE.

20. The apparatus of claim 11, wherein during operation, the processor performs operations comprising:
receiving, via the non-3GPP transceiver, a feedback message for the data packets from the relay UE after the data packets are transmitted to the network node from the relay UE; and
retransmitting, via the non-3GPP transceiver, data packet which has not transmitted to the network node successfully to the network node according to the feedback message.
